(19) United States
(12) Patent Application Publication
(10) Pub. No.: US 2003/0058508 A1
(43) Pub. Date: Mar. 27, 2003

(54) RZ optical transmission

(75) Inventors: Steve Webb, Kent (GB); Steve Desbruslais, London (GB)

Correspondence Address: BEYER WEAVER & THOMAS LLP, P.O. BOX 778, BERKELEY, CA, 94704-0778, US

(73) Assignee: Ditech Communications Corporation

(21) Appl. No.: 09/962,773

(22) Filed: Sep. 24, 2001

(51) Int. Cl. H04B 10/04

(52) U.S. Cl. 359/181; 359/180

(57) ABSTRACT

A method and apparatus for transmitting optical data in an RZ modulation format is provided, which comprises passing a chirped NRZ encoded optical signal through a dispersive element to cause the light to bunch into packets centered on a respective clock cycle. An optical NRZ signal is transformed into a chirped RZ format by applying optical phase or frequency modulation at the data clock rate, and subsequently passing it through linear chromatic dispersion. The architecture required to perform this function can be implemented using a single Lithium Niobate substrate incorporating two modulation functions.

### BACKGROUND TO THE INVENTION

Long haul optical data transmission at 10 Gbit/s often utilises a Chirped RZ modulation format. A Chirped RZ format improves the detection of the optical signal since distortions to the signal during transmission are generally symmetrical so that all data is distorted equally.

A known architecture used to generate such an RZ signal from NRZ electrical data uses three concatenated Lithium Niobate modulators. The first two are Mach Zehnder (MZ) modulators and the third is a phase modulator. In this arrangement, the phase modulation is via a clock signal adjusted so that one half of a data pulse is red shifted and the other half blue shifted. This is termed “clock pre-chirp”. Although the architecture provides high performance transmission quality, the number of separate modulators required to generate an RZ signal with clock pre-chirp makes the design expensive and complicated.

It is possible to integrate more than one function onto a single Lithium Niobate substrate, but at 10 Gbit/s this is limited to two modulation functions due to technology limits. The objective is to achieve high quality chirped RZ format with one modulator package to reduce component count and assembly size and cost.

### SUMMARY OF THE INVENTION

According to a first aspect of the present invention, a method of transmitting optical data in an RZ modulation format comprises the step of passing a chirped NRZ encoded optical signal through a dispersive element to cause the light to bunch into packets centered on a respective clock cycle.

Preferably, the chirped NRZ encoded optical signal is generated by passing an NRZ optical signal through a phase modulator driven by a clock. Alternatively, the chirped NRZ encoded signal is generated by applying a clock to a laser source to produce a frequency modulated output which is then modulated by an NRZ electrical data signal.

According to a second aspect of the present invention, an optical transmitter for generating an optical data signal having an RZ format, comprises a signal modulator that generates a chirped NRZ optical signal, the output of the signal modulator being coupled to a dispersive element that perturbs the optical signal so that each bit of data bunches into a packet centered on a respective clock cycle.

Preferably, the signal modulator comprises a Mach Zender (MZ) modulator driven by an NRZ electrical data signal, and a phase modulator driven by a clock signal that applies clock pre-chirp.

Preferably, the clock signal is derived from the electrical data signal.

The dispersion element may be a length of dispersion compensation fibre.

Alternatively, the dispersion element may be a fibre Bragg grating (FBG).

Preferably, the dispersion element introduces a degree of dispersion given by the equation:

$$Dispersion = \frac{C}{2 {( λ B )}^{2}}$$

Preferably, the phase amplitude (Φₐ) is adjusted so that:

Jₒ(Φa)=2J₁(Φa)

In the present invention, an optical NRZ signal may be transformed into a chirped RZ format by applying optical phase or frequency modulation at the data clock rate, and subsequently passing it through linear chromatic dispersion. The architecture required to perform this function can be implemented using a single Lithium Niobate substrate incorporating two modulation functions.

### BRIEF DESCRIPTION OF THE DRAWINGS

Examples of the present invention will now be described in detail with reference to the accompanying drawings, in which:

FIG. 1 shows an architecture for generating a chirped RZ optical signal; and,

FIGS. 2A and 2B are an eye diagram and signal waveforms, respectively, for a chirped RZ signal generated using 680 ps nm⁻¹ of pre-dispersion compensation; and,

FIGS. 3A and 3B are an eye diagram and signal waveforms, respectively, for a chirped RZ signal generated using 340 ps nm⁻¹ of pre-dispersion compensation.

### DETAILED DESCRIPTION

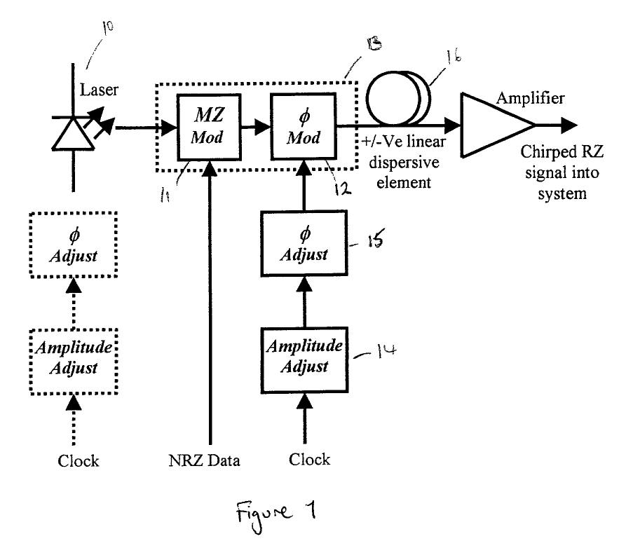

Two schemes for conversion of optical NRZ signals to RZ optical signals according to the present invention are presented in FIG. 1.

The preferred implementation consists of a CW laser 10, for example a DFB laser, that is coupled to an integrated MZ modulator 11 and phase modulator 12 component 13 (implemented using an MZ modulator device on the same substrate). NRZ electrical data is applied to the MZ modulator 11. A clock derived from the original data signal is then applied to the phase modulator after it has passed through adjustable attenuation and delay elements 14 and 15 respectively. The optical signal at the output of the MZ component 13 then undergoes linear dispersion of positive or negative sign. Typically, the dispersion element 16 is arranged to be fibre with a low optical power to ensure non-linear signal transforms are prevented. It is possible to use other dispersive elements such as chirped Fibre Bragg Gratings (FBG's).

The amplitude and phase of the clock signal with respect to the data signal are arranged to produce the correct optical clock pre-chirp such that an NRZ to RZ signal is achieved after the dispersive element 16. The process is due to the optical red/blue shifts on alternate halves of each data bit with dispersion causing the light to bunch into packets centred on a clock cycle.

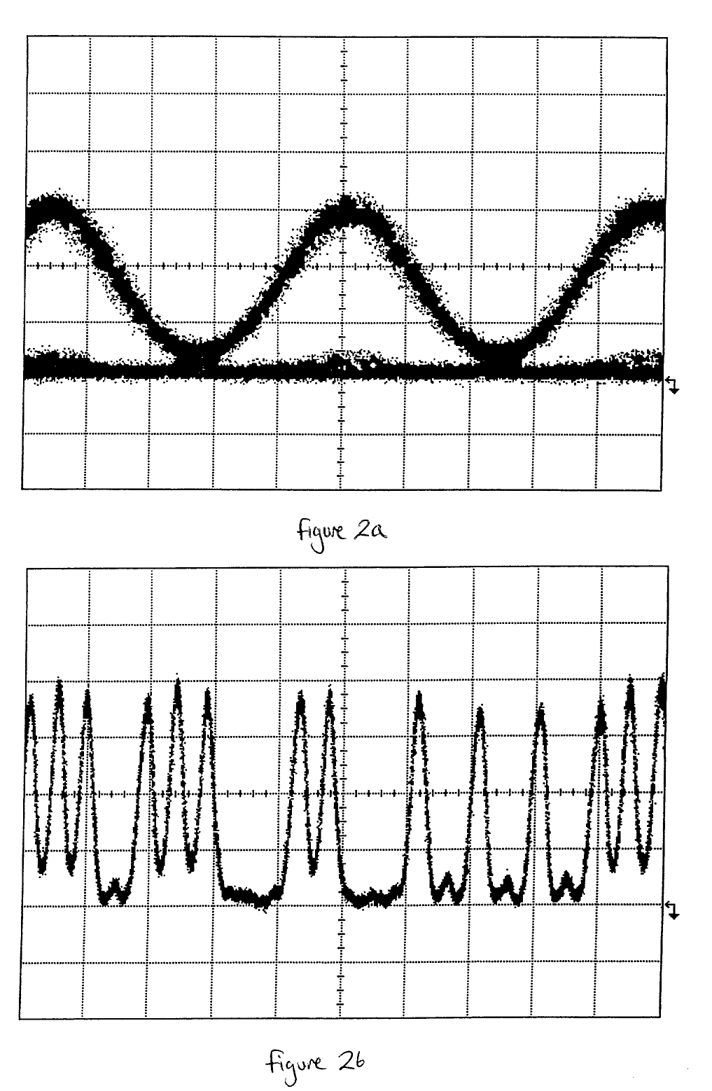

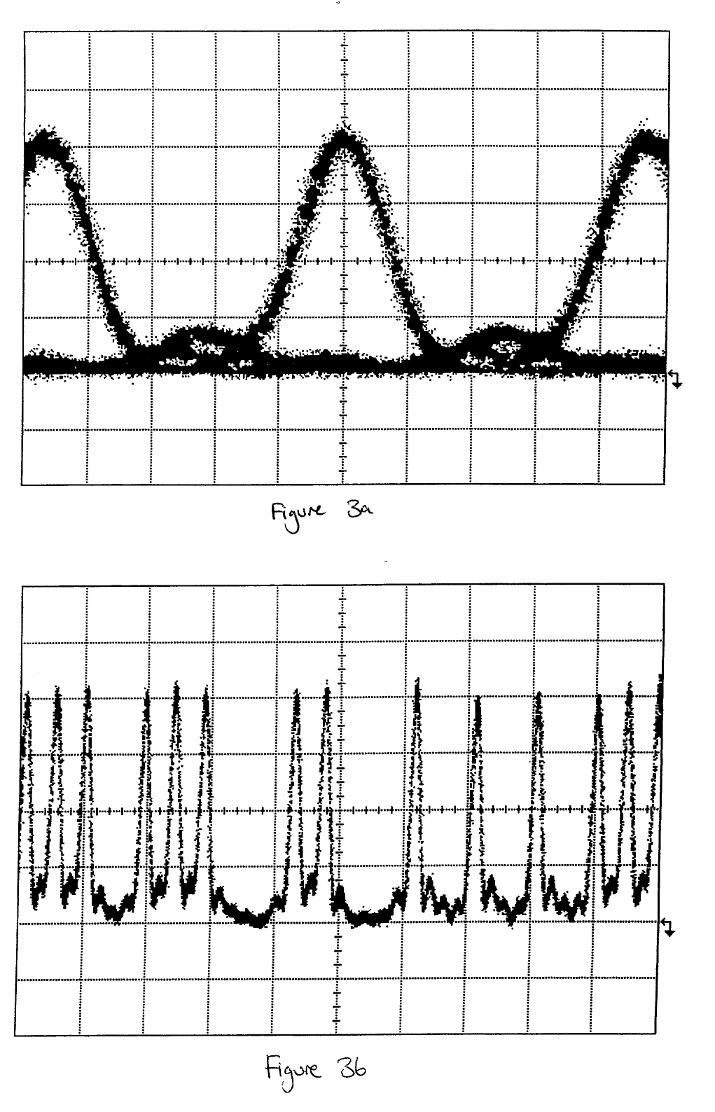

A dispersion map is used to achieve optimal transmission in any long haul high bit-rate system. Typically, this involves pre- and post-dispersion compensation at the system beginning and end. In this design the pre-dispersion element is used as an NRZ to RZ transformation component. Our experimental investigations show that at a wavelength of 1555 nm₂ and 10 Gbit/sec bit rate, the degree of dispersion required is 680 ps nm⁻¹. The effect of this is shown in FIGS. 2A and 2B. The effect of reducing this amount of dispersion by half is indicated in FIGS. 3A and 3B. Here the conversion is less optimal and increased phase modulation is required to achieve an RZ signal. The net result is a reduced pulse width.

More generally, the degree of dispersion (in PS nm⁻¹) required is given by the following equation:

$$Dispersion = \frac{C}{2 {( λ B )}^{2}} \times 1000$$

where c is the speed of light, λ is the wavelength of the optical signal, and B is the bit rate of the optical signal.

The phase amplitude (Φₐ) is adjusted so that:

Jₒ(Φₐ)=2J₁(Φₐ)

The alternative implementation intimated in FIG. 1 (by the dotted lines) involves applying a clock signal to the CW laser in order to frequency modulate it. Typically, a standard DFB laser will exhibit about 1 GHz optical wavelength shift per mA of injection current applied (due to changes in the internal refractive index). The required currents are sufficiently small that very little unwanted amplitude modulation will be seen. The frequency modulation applied is an analogy of the pre-chirp via phase modulation described above.

As shown in FIG. 1, the optical signal may then pass through an amplifier 17 to boost the signal powers before entering a transmission system. Typically, the signal will undergo non-linear transformations during propagation for which the format has been shown to be robust against. Balancing of the exact phase and amplitude is required to achieve optimal transmission, which may be controlled via a feedback loop (not shown).

1. A method of transmitting optical data in an RZ modulation format comprising the step of:
passing a chirped NRZ encoded optical signal through a dispersive element to cause the light to bunch into packets centred on a respective clock cycle.

2. A method according to claim 1, wherein the chirped NRZ encoded optical signal is generated by passing an NRZ optical signal through a phase modulator driven by a clock.

3. A method according to claim 1, wherein the chirped NRZ encoded signal is generated by applying a clock to a laser source to produce a frequency modulated output which is then modulated by an NRZ electrical data signal.

4. An optical transmitter for generating an optical data signal having an RZ format, comprising:
a signal modulator that generates chirped NRZ optical signal, the output of the signal modulator being coupled into a dispersive element that perturbs the optical signal so that each bit of data bunches into a packet centred on a respective clock cycle.

5. An optical transmitter according to claim 4, wherein the signal modulator comprises a Mach Zender modulator driven by an NRZ electrical data signal; and,
a phase modulator driven by a clock signal that applies to a clock pre-chirp.

6. An optical transmitter according to claim 5, wherein the clock signal is derived from the electrical data signal.

7. An optical transmitter according to any one of claims 4 to 6, wherein the dispersion element is a length of dispersion compensation fibre.

8. An optical transmitter according to any one of claims 4 to 6, wherein the dispersion element is a fibre Bragg grating.

9. An optical transmitter according to any one of claims 4 to 8, wherein the dispersion element introduces a degree of dispersion given by the equation;
$$Dispersion = \frac{C}{2 {( λ B )}^{2}}$$

10. An optical transmitter according to any one of claims 4 to 9, wherein the phase amplitude (Φₐ) is adjusted so that:
Jₒ(Φₐ)=2J₁(Φₐ)

11. An optical transmitter according to any one of claims 4 to 10, comprising a single Lithium Niobate substrate incorporating two modulation functions.
